(19) United States
(12) Patent Application Publication
(10) Pub. No.: US 2013/0174425 A1
(43) Pub. Date: Jul. 11, 2013

(54) Cutting Device

(71) Applicants: Scott NEAL, Sturbridge, MA (US); David WOLFF, Chesnee, SC (US); Glen BURKE, Chesnee, SC (US)

(72) Inventors: Scott NEAL, Sturbridge, MA (US); David WOLFF, Chesnee, SC (US); Glen BURKE, Chesnee, SC (US)

(21) Appl. No.: 13/344,954

(22) Filed: Jan. 6, 2012

(51) Int. Cl. B26B 3/04; A22B 5/16

(52) U.S. Cl. 30/303; 30/299; 30/304

(57) ABSTRACT

A cutting device is disclosed. The cutting device includes a handle having an outer surface, the outer surface having a first end and a second end and defining a width. The cutting device further includes a plurality of blades coupled to the handle and extending from the first end. Each of the plurality of blades is spaced apart from another of the plurality of blades in a generally width-wise direction. The cutting device further includes a channel defined in the handle extending from the first end generally towards the second end. The channel is spaced from the neighboring blades in the generally width-wise direction and comprising a recess and an opening. The outer surface defines the opening. The channel allows movement of at least one of the plurality of blades in the generally width-wise direction with respect to another of the plurality of blades.

### TECHNICAL FIELD

The present disclosure relates to cutting devices, and more particularly to cutting devices having multiple blades.

### BACKGROUND

A wide variety of cutting devices are utilized for various activities involving cutting, slicing, trimming and chopping various items. For example, cutting devices are frequently used in the kitchen, the butcher's shop, or the food processing plant to cut, slice, trim, and chop various foods. One particular application of cutting devices is during deboning of an animal, such as a chicken, during processing.

In many cases, it is desirable when deboning an animal using a cutting device to maintain the cutting device in close proximity to the bone of the animal. This allows for more meat to be cut from the bone and passed on to the consumer for consumption. However, many known cutting device have only single blades, making it difficult to maintain such close proximity to the bone. Other cutting devices include more than one blade. However, such blades are rigid with respect to one another. Thus, the blades cannot accommodate changes to the contour of the bone of the animal. This results in more meat being left on the bone, and less meat being passed on to the consumer. This is of particular concern in the chicken-processing industry, due to the relatively small size of the chicken and the resulting increased desirability in obtaining as much meat as possible from the chicken bone.

In view of the above, an improved cutting device would be desired in the art. For example, an improved cutting device for food processing would be advantageous. In particular, a cutting device that allows for cutting in close proximity to the bone of the animal being processed would be desired.

### SUMMARY

Aspects and advantages of the invention will be set forth in part in the following description, or may be obvious from the description, or may be learned through practice of the invention.

In one embodiment, a cutting device is disclosed. The cutting device includes a handle having an outer surface, the outer surface having a first end and a second end and defining a width. The cutting device further includes a plurality of blades coupled to the handle and extending from the first end. Each of the plurality of blades is spaced apart from another of the plurality of blades in a generally width-wise direction. The cutting device further includes a channel defined in the handle extending from the first end generally towards the second end. The channel is spaced from the neighboring blades in the generally width-wise direction and comprising a recess and an opening. The outer surface defines the opening. The channel allows movement of at least one of the plurality of blades in the generally width-wise direction with respect to another of the plurality of blades.

In some embodiments, the plurality of blades includes a first blade and a second blade, and the channel is positioned between the first blade and the second blade in the generally width-wise direction. The blades may further have various angles with respect to the handle and with respect to each other.

In some embodiments, the handle includes a plurality of handle segments, such as a first handle portion and a second handle portion. The handle segments may be pivotable with respect to one another and/or may be separable. The handle segments may further include various coupling and/or locating features.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a front perspective view of a cutting device in a closed, non-pressed position according to one embodiment of the present disclosure;

FIG. 2 is a rear perspective view of a cutting device in a closed, non-pressed position according to one embodiment of the present disclosure;

FIG. 3 is a front view of a cutting device in a closed, non-pressed position according to one embodiment of the present disclosure;

FIG. 4 is a front view of a cutting device in a closed, pressed position according to one embodiment of the present disclosure;

FIG. 5 is a top view of a cutting device in a closed, non-pressed position according to one embodiment of the present disclosure;

FIG. 6 is a perspective view of a cutting device in an open position according to one embodiment of the present disclosure; and

FIG. 7 is a perspective view of a cutting device in an uncoupled position according to one embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to a cutting device, such as a knife. The cutting device may be utilized to cut, slice, trim, or chop various items, such as foods. One particular application of cutting devices is during deboning of an animal, such as a chicken, during processing. Cutting devices according to the present disclosure are particularly advantageous in animal processing applications due to various features which allow the cutting device to contour to the bone of the animal. These features can facilitate faster deboning and higher quality resulting products.

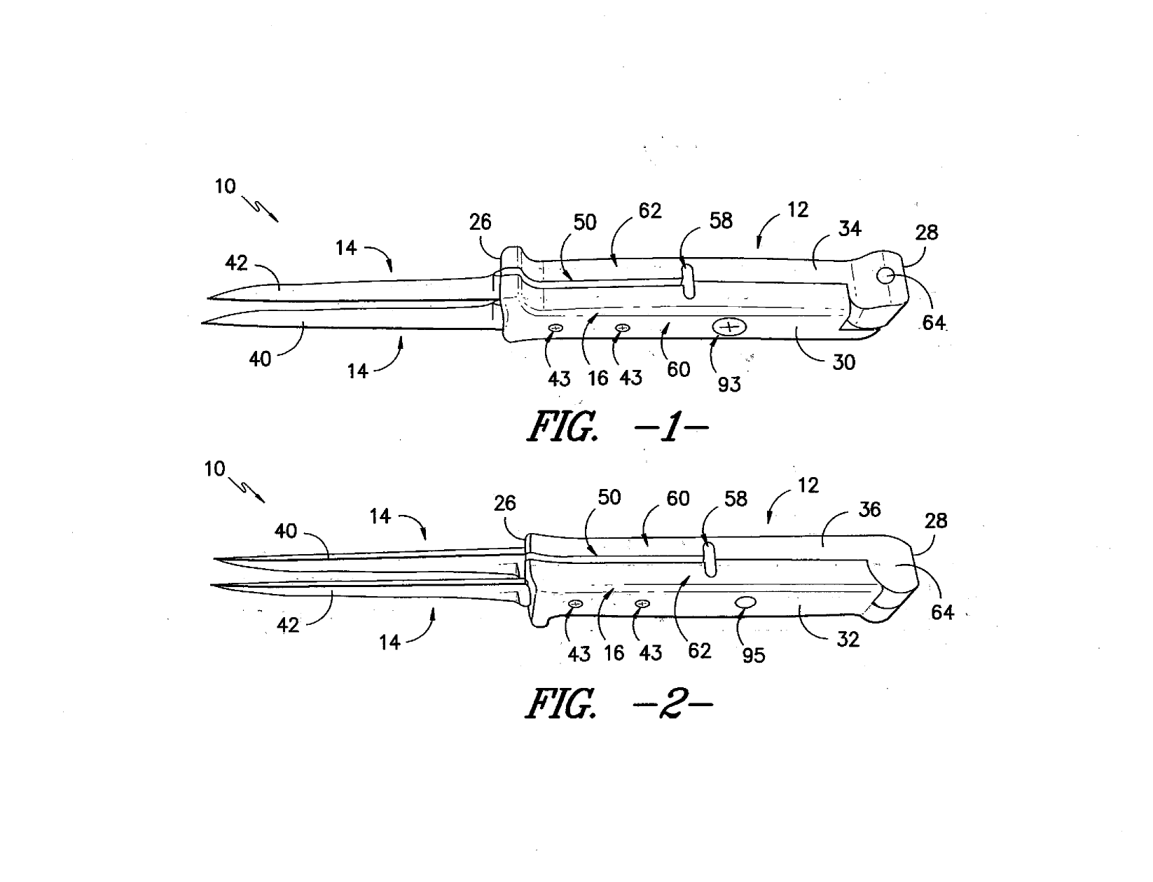

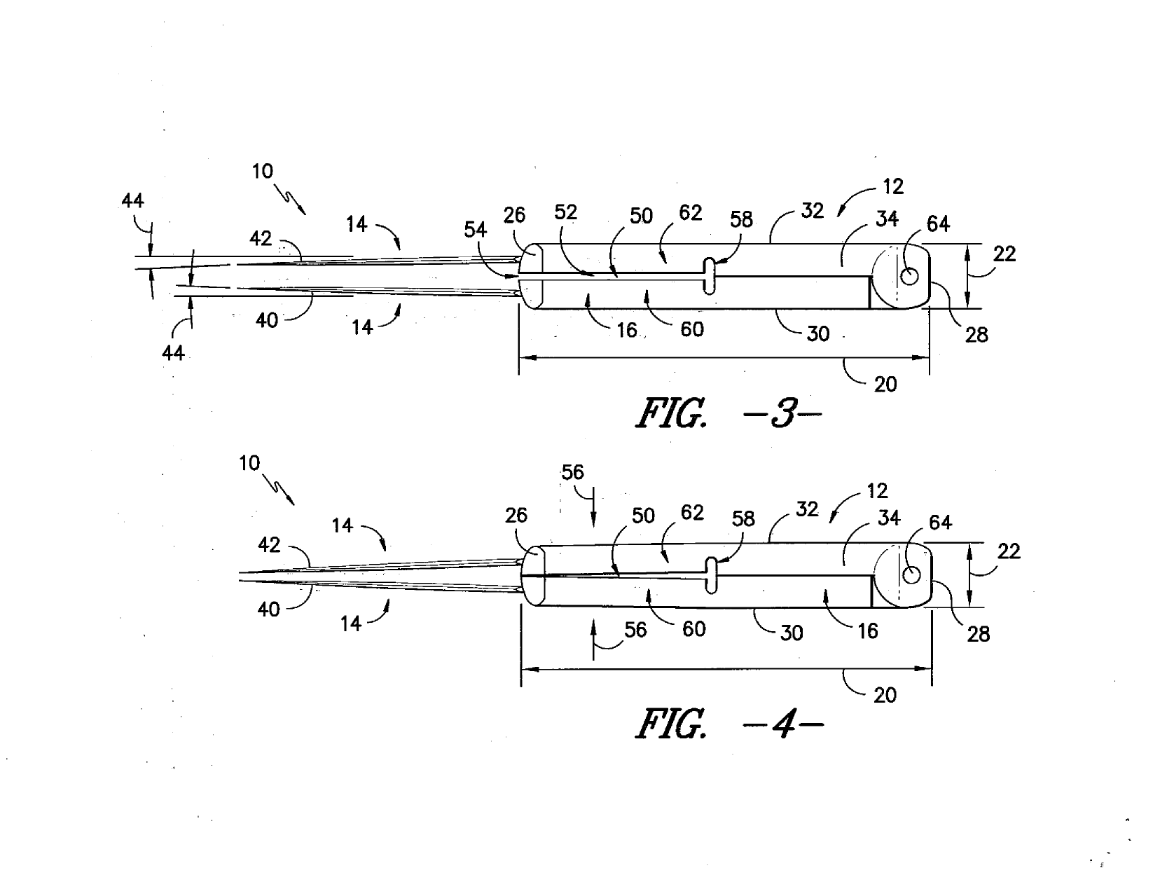

Referring now to FIGS. 1 through 7, one embodiment of a cutting device 10 according to the present disclosure is disclosed. The cutting device 10 includes a handle 12 and a plurality of blades 14 extending from the handle 12. The handle 12 may generally have any shape and size suitable for a user to grip the handle 12. Further, the handle 12 includes an outer surface 16, and may define a length 20, a width 22, and a thickness 24. As shown, the length 20 may be defined between a first end 26 and a second end 28 of the handle 12, and may vary throughout the width 22 and/or thickness 24 or any portions thereof. The width 22 may be defined in a direction generally perpendicular to the length 20 and thickness 24 and across the plurality of blades 14, and may vary throughout the length 20 and/or thickness 24 or any portions thereof. The thickness may be defined in a direction generally perpendicular to the length 20 and the width 22, and may vary throughout the length 20 and the width 22 or any portions thereof.

In some embodiments, the handle 12 further includes a first side surface 30 and a second side surface 32, each of which may define the length 20 and thickness 24. The side surfaces 30, 32 may each extend between a front surface 34 and a rear surface 36, each of which may define the length 20 and width 22. Each surface 30, 32, 34, 36, along with the first end 26 and second end 28, or any portion thereof, may be generally planer, having a linear cross-sectional profile, or may be generally curvi-planer, having a curvilinear cross-sectional profile, or may have any other suitable shape and cross-sectional profile.

As discussed, a plurality of blades 14 may extend from the handle 12. As shown, each blade 14 according to the present disclosure may be spaced apart from one or more other blades 14 of the plurality of blades along the width 22, such as in a generally width-wise direction. In exemplary embodiments, the plurality of blades 14 includes a first blade 40 and a second blade 42. It should be understood, however, that the present disclosure is not limited to a cutting device 10 having two blades 14, and rather that a cutting device 10 having three, four, or more blades 14 is within the scope and spirit of the present disclosure. It should further be understood that each blade 14 may be a straight-edged blade, serrated-edge blade, or a blade with any other edge design known in the art.

Each blade 14 according to the present disclosure may be coupled to the handle 12. For example, in some embodiments, a blade 14 may be coupled to the handle 12 through injection molding as shown in FIG. 7. Thus, the blade 14 may be placed in a mold of the handle 12, and the handle 12 injection molded around the blade 14. In other embodiments, a blade 14 may be coupled to the handle 12 by one or more mechanical fasteners 43, as shown in FIGS. 1, 2 and 7. The mechanical fastener 43 may be a rivet, screw, nail, nut and bolt combination, or any other suitable device for mechanically fastening a blade 14 to a handle 12. Further, a blade 14 may be coupled to a handle 12 through any other suitable devices or processes.

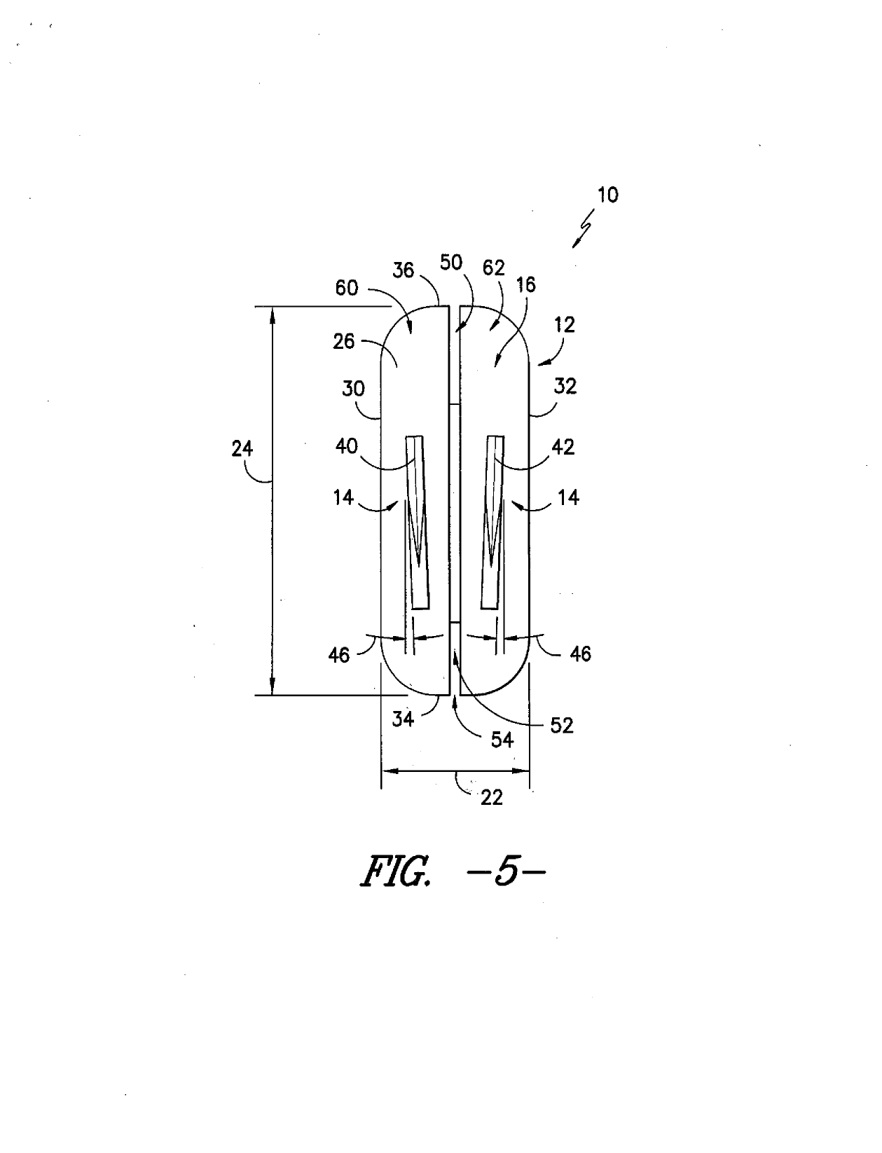

Each blade 14 may extend from the first end 26 of the handle 12, such that a tip of the blade 14 is spaced from the handle 12. In some embodiments, one or more blades 14 may extend generally parallel to the length 20, thus extending in a length-wise direction. In other embodiments, as shown in FIG. 3, one or more blades 14 may extend at an angle 44 to the length-wise direction. As shown, the angle 44, which may be known as a cant angle, may be defined with respect to the length-wise direction and in the length 20-width 22 plane. The angle 44 may be in the range between, for example, approximately 0 degrees and approximately 5 degrees, approximately 0 degrees and approximately 3 degrees, approximately 0 degrees and approximately 2 degrees, approximately 0 degrees and approximately 1 degree, or may be at any other suitable angle or range of angles. Further, the angle 44 of a blade 14 may shift that blade 14 generally towards or away from another of the plurality of blades 14. For example, in exemplary embodiments as shown wherein the plurality of blades 14 includes a first blade 40 and second blade 42, the angles 44 of the blades 40 and 42 may shift the blades 40 and 42 generally towards each other. This may result in the distance between the tips of the blades 40 and 42 being closer than the distance between the bases (defined at the intersection of the blade 14 and the outer surface 16 of the handle 12). For example, in particular exemplary embodiments, the distance between the bases in a closed, non-pressed position as discussed below may be approximately one-quarter inch, while the distance between the tips may be approximately one-eighth inch. It should be understood, however, that the present disclosure is not limited to the above-disclosed distances, and rather that any suitable distances are within the scope and spirit of the present disclosure.

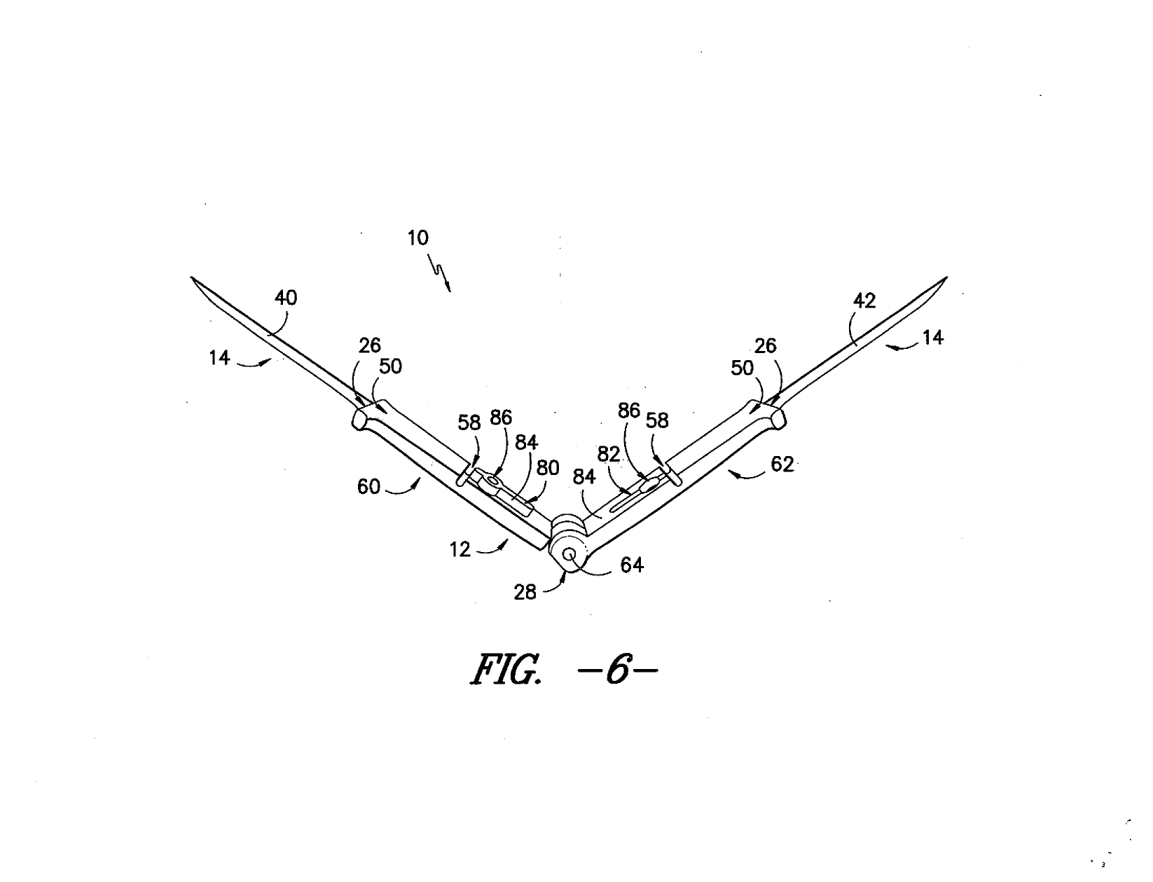

A blade 14 according to the present disclosure may, in some embodiments as shown in FIG. 5, further define an angle 46 to a thickness-wise direction running along the thickness 24. As shown, the angle 46, which may be known as a twist angle, may be defined with respect to the thickness-wise direction and in the width 22-thickness 24 plane. The angle 46 may be in the range between, for example, approximately 0 degrees and approximately 5 degrees, approximately 0 degrees and approximately 3 degrees, approximately 0 degrees and approximately 2 degrees, approximately 0 degrees and approximately 1 degree, or may be at any other suitable angle or range of angles.

As shown in FIGS. 1 through 5, one or more channels 50 may be defined in the handle 12. A channel 50 may advantageously allow one or more of the blades 14 to move in the width-wise direction with respect to others of the blades 14. In food processing applications, and in particular in chicken deboning applications, this may advantageously allow the distance between the blades 14 to change, allowing the blades 14 to contour to the bone of the animal. This may allow for faster processing, and may allow for more meat to be obtained from the animal, which can be passed on to the consumer. For example, the present inventors have discovered that some embodiments of the cutting device 10 of the present disclosure can provide an increase of 10 to 50 points in tender score cuts for chicken, which can dramatically improve the yield passed on to the consumer.

The channel 50 extends from the first end 26 generally towards the second end 28, which may be for example in a generally length-wise direction. It should be understood that the channel 50 may extend parallel to the length 20 or at an angle to parallel, and may extend generally linearly or curvilinearly. As shown, the channel 50 includes a recess 52 and an opening 54, and the outer surface 16 of the handle 12 defines the opening 54. Further, the channel 50 may be spaced from neighboring blades 14 in the generally width-wise direction, such that it is defined between the blades 14. For example, in exemplary embodiments wherein the cutting device 10 includes a first blade 40 and a second blade 42, the channel 50 may be positioned between the first blade 40 and the second blade 42 in the generally width-wise direction.

As discussed, a channel 50 according to the present disclosure allows movement of at least one of the plurality of blades 14 in the generally width-wise direction with respect to another of the plurality of blades 14. For example, FIGS. 1 through 3 and 5 illustrate one embodiment of a cutting device 10 in a non-pressed position. FIG. 4 illustrates one embodiment of a cutting device 10 in a pressed position. To move the blades 14, such as the first and second blades 40 and 42, with respect to one another in the generally width-wise direction, the handle 12 may be pressed generally in the direction of arrows 56 by, for example, the hand of a user gripping the handle 12. For example, the side surfaces 30 and 32 may be pressed. The channel 50 may be narrowed and, in some locations, closed, and the blades 14 may thus be moved closer together as shown in FIG. 4. When pressing of the handle 12 is discontinued, the blades 14 may return to the non-pressed position, as shown in FIGS. 1 through 3 and 5. Varying the pressure with which the handle 12, such as the side surfaces 30, 32 thereof, is pressed may vary the movement of the blades 14 with respect to one another.

Thus, in some embodiments during use in, for example, a chicken processing plant, the blades 14 can be placed on either side of a bone of the chicken, such as a backbone. The handle 12 can then be pressed as necessary with varying amounts of pressure to move the blades 14 such that they run along the sides of the bone, and such that the distance between the blades 14 varies with the contour of the bone.

In exemplary embodiments as shown, the opening 54 of the channel 50 is defined in the first end 26. Further, the opening 54 may be defined in the front surface 34 and/or the rear surface 36 as shown. The opening 54 may extend through any portion of the length 20 of the handle 12 from the first end 26.

In some embodiments, the channel 50 may further include a relief notch portion 58. The relief notch portion 58 may be a portion of the channel 50 having a greater width than the remainder of the channel 50. For example, a relief notch portion 58 may be included at an end of the channel 50 spaced from the first end 26 of the handle 12, or may be defined at any suitable length-wise location along the channel 50.

In some embodiments, the handle 12 is a singular, unitary structure. In other embodiments, as shown in FIGS. 1 through 7, the handle 12 may be formed from a plurality of segments. For example, in some embodiments, a handle 12 according to the present disclosure may include a first handle portion 60 and a second handle portion 62. Further, each of the handle portions 60, 62 may have at least one blade 14 extending therefrom. For example, as shown, a first handle portion 60 may have a first blade 40 extending therefrom, and a second handle portion 62 may have a second blade 42 extending therefrom. A channel 50 may, for example, be defined between the first and second handle portions 60, 62. Further, it should be understood that the present disclosure is not limited to a handle 12 having one or two segments, and rather that a handle 12 having any number of segments is within the scope and spirit of the present disclosure.

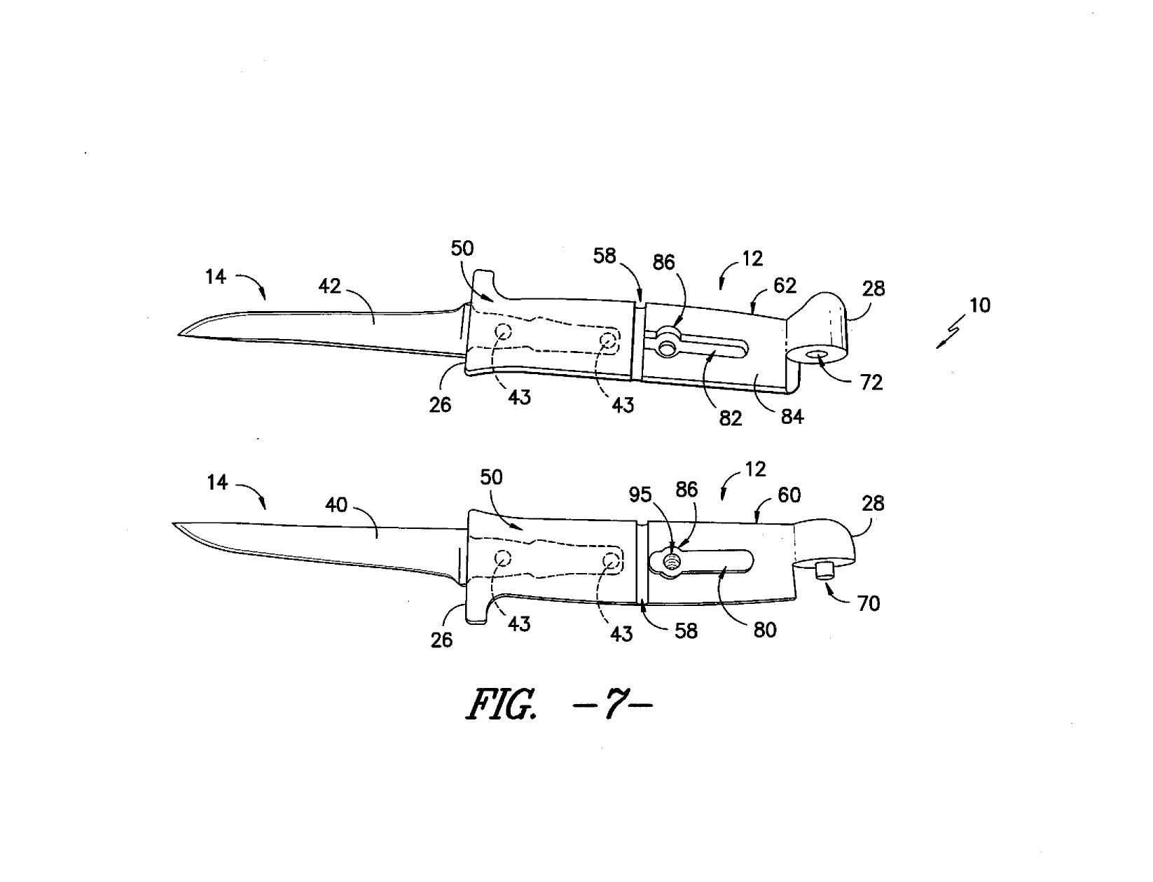

The various handle segments may, in some embodiments, be pivotable with respect to one another. For example, FIGS. 1 through 5 show one embodiment of a cutting device 10 in a closed position wherein first and second handle portions 60, 62 have been pivoted generally together. FIG. 6 shows one embodiment of a cutting device 10 in an open position wherein the first and second handle portions 60, 62 have been pivoted apart. Pivoting of the handle portions 60, 62 or other segments with respect to each other may occur about pivot points 64, as shown. Pivoting of the various segments to open positions may allow for ease of cleaning, sharpening, and otherwise manipulating the cutting device 10 and various blades 14 thereof.

The various handle segments may, in some embodiments, be separable from one another. For example, FIGS. 1 through 6 show one embodiment of a cutting device 10 wherein first and second handle portions 60, 62 have been coupled together. FIG. 7 shows one embodiment of a cutting device 10 wherein first and second handle portions 60, 62 have been uncoupled from each other and thus separated. Separating of the various segments may allow for ease of cleaning, sharpening, and otherwise manipulating the cutting device 10 and various blades 14 thereof, and may further allow for individual blades 14 and/or handle segments to be utilized separately from other blades 14 and/or handle segments.

In some embodiments as shown, the various handle segments, such as the first handle portion 60 and second handle portion 62, include coupling members for coupling the segments together and allowing separation thereof. For example, as shown in FIGS. 1 through 7, one of the first handle portion 60 or second handle portion 62 may include a male coupling member 70, and the other of the first handle portion 60 or second handle portion 62 may include a mating female coupling member 72. The male coupling member 70 may be a protrusion, while the female coupling member 72 may be a depression sized and shaped to accommodate the male coupling member 70. The coupling members 70, 72 may be coupled together and uncoupled to separate the handle portions 60, 62 by aligning and moving the coupling members 70, 72 with respect to one another generally towards or away from each other, in the width-wise direction, as shown, or in the length-wise direction or thickness-wise direction. Thus, when the handle portions 60 and 62 are brought together to a coupled position as shown and discussed above, the male coupling member 70 may be accepted in the female coupling member 72 to couple the handle portions 60 and 62 together.

The coupling members 70, 72 may be disposed on or adjacent to the second end 28 of the handle, or at any other suitable length-wise location. Further, in exemplary embodiments as shown, the female coupling member 72 may pivot about the male coupling member 70, such that the coupling members 70 and 72 form and define a pivot point 64 for the handle 12.

In some embodiments as shown in FIGS. 6 and 7, each handle segment, such as each of the first and second handle portions 60, 62, may include locating members for locating the handle segments with respect to one another when coupled together and/or placed in a closed position. The locating members may prevent slippage or other undesirable movement of the handle segments with respect to one another during, for example, use of the cutting device. For example, as shown in FIGS. 6 and 7, one of the first handle portion 60 or second handle portion 62 may include a male locating member 80, and the other of the first handle portion 60 or second handle portion 62 may include a mating female locating member 82. The male locating member 80 may be a protrusion, while the female locating member 82 may be a depression sized and shaped to accommodate the male locating member 80. The male locating member 80 may be included on, and the female locating member 82 may be defined on, an inner surface 84 of a respective blade segment, such as a first handle portion 60 or second handle portion 62. Thus, when the handle portions 60 and 62 are brought together to a closed position as shown and discussed above, the male locating member 80 may be accepted in the female locating member 82 to locate and thus position the handle portions 60 and 62 with respect to each other.

The locating members may have any suitable shapes and sizes. In some embodiments, a key portion 86 may be included on each locating member, as shown. A key portion is a portion of a locating member that has a relatively larger or smaller cross-sectional or plan view profile than the remainder of the locating member, thus allowing only the mating key portion to mate therewith. The key portion 86 may be located adjacent to an end of each locating member, or may be located at the center of each locating member. The key portion 86 may further facilitate proper mating of the locating members, such as the male and female locating members 80 and 82, with respect to each other to locate and thus position the handle portions 60 and 62 with respect to each other.

Additionally, in some embodiments, the various handle segments, such as the first handle portion 60 and second handle portion 62, may be locked together in the closed position. For example, a mechanical fastener 93 may extend through both the first handle portion 60 and second handle portion 62. The mechanical fastener 93 may be fastened directly to one or both handle portions 60, 62, or may be fastened to an insert 95 disposed within one or both handle portions 60, 62 as shown. For example, in some embodiments, the mechanical fastener 93 may be a screw, and mating threads of the screw and handle portions 60, 62 or insert 95 as shown may fasten them together. In exemplary embodiments, the mechanical fastener 93 and the insert 95 may be disposed within the locating members, such as within the key portions thereof. Such fastening of the mechanical fastener 93, such as with the insert 95, may lock the first handle portion 60 and second handle portion 62, and thus the cutting device 10 in general, in the closed position. The mechanical fastener 93 can be removed to unlock the cutting device 10 and allow the cutting device 10 to be placed in an open position.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cutting device, comprising:
a handle comprising an outer surface, the outer surface comprising a first end and a second end and defining a width;
a plurality of blades coupled to the handle and extending from the first end, each of the plurality of blades spaced apart from another of the plurality of blades in a generally width-wise direction; and
a channel defined in the handle extending from the first end generally towards the second end, the channel spaced from the neighboring blades in the generally width-wise direction and comprising a recess and an opening, the outer surface defining the opening,
wherein the channel allows movement of at least one of the plurality of blades in the generally width-wise direction with respect to another of the plurality of blades.

2. The cutting device of claim 1, wherein the outer surface further comprises a first side surface and a second side surface each extending between a front surface and a rear surface, and wherein the opening is defined in the first end, the front surface, and the rear surface.

3. The cutting device of claim 1, wherein the plurality of blades comprises a first blade and a second blade, and wherein the channel is positioned between the first blade and the second blade in the generally width-wise direction.

4. The cutting device of claim 3, wherein at least one of the first blade and the second blade extends at an angle to a length-wise direction in the range between approximately 0 degrees and approximately 5 degrees.

5. The cutting device of claim 3, wherein at least one of the first blade and the second blade defines an angle to a thickness-wise direction in the range between approximately 0 degrees and approximately 5 degrees.

6. The cutting device of claim 1, wherein the handle further comprises a first handle portion and a second handle portion, each of the first handle portion and the second handle portion having at least one of the plurality of blades extending therefrom.

7. The cutting device of claim 6, wherein the first handle portion and second handle portion are pivotable with respect to each other about a pivot point.

8. The cutting device of claim 6, wherein the first handle portion and second handle portion are separable.

9. The cutting device of claim 8, wherein one of the first handle portion or the second handle portion comprises a male coupling member and wherein the other of the first handle portion or the second handle portion comprises a mating female coupling member.

10. The cutting device of claim 6, wherein one of the first handle portion or the second handle portion comprises a male locating member extending from an inner surface thereof, and wherein the other of the first handle portion or the second handle portion comprises a mating female locating member defined on an inner surface thereof.

11. The cutting device of claim 1, wherein at least one of the plurality of blades is coupled to the handle through injection molding.

12. The cutting device of claim 1, wherein at least one of the plurality of blades is coupled to the handle by a mechanical fastener.

13. A cutting device, comprising:
a handle comprising an outer surface, the outer surface comprising a first end and a second end and defining a width;
a first blade and a second blade each coupled to the handle and extending from the first end, each of the first blade and second blade spaced apart from each other in a generally width-wise direction; and
a channel defined in the handle extending from the first end generally towards the second end, the channel positioned between the first blade and the second blade in the generally width-wise direction and comprising a recess and an opening, the outer surface defining the opening,
wherein the channel allows movement of first blade and the second blade in the generally width-wise direction with respect to each other.

14. The cutting device of claim 13, wherein the outer surface further comprises a first side surface and a second side surface each extending between a front surface and a rear surface, and wherein the opening is defined in the first end, the front surface, and the rear surface.

15. The cutting device of claim 1, wherein at least one of the first blade and the second blade extends at an angle to a length-wise direction in the range between approximately 0 degrees and approximately 5 degrees.

16. The cutting device of claim 1, wherein at least one of the first blade and the second blade defines an angle to a thickness-wise direction in the range between approximately 0 degrees and approximately 5 degrees.

17. The cutting device of claim 1, wherein the handle further comprises a first handle portion and a second handle portion, the first handle portion having the first blade extending therefrom and the second handle portion having the second blade extending therefrom.

18. The cutting device of claim 17, wherein the first handle portion and second handle portion are pivotable with respect to each other about a pivot point.

19. The cutting device of claim 17, wherein the first handle portion and second handle portion are separable.

20. The cutting device of claim 17, wherein one of the first handle portion or the second handle portion comprises a male locating member extending from an inner surface thereof, and wherein the other of the first handle portion or the second handle portion comprises a mating female locating member defined on an inner surface thereof.
